(19) United States
(12) Patent Application Publication
(10) Pub. No.: US 2017/0285396 A1
(43) Pub. Date: Oct. 5, 2017

(54) ELECTRO-OPTICAL DEVICE, ELECTRONIC APPARATUS, AND METHOD OF MANUFACTURING ELECTRO-OPTICAL DEVICE

(71) Applicant: SEIKO EPSON CORPORATION, Tokyo (JP)

(72) Inventor: Toru NIMURA, Matsumoto-shi (JP)

(73) Assignee: SEIKO EPSON CORPORATION, Tokyo (JP)

(21) Appl. No.: 15/473,764

(22) Filed: Mar. 30, 2017

(30) Foreign Application Priority Data
Apr. 4, 2016 (JP) 2016-074975

(51) Int. Cl. G02F 1/1335; G02F 1/1362; G02F 1/1368; G02F 1/1343

(52) U.S. Cl. CPC G02F 1/133526; G02F 1/134309; G02F 1/136209; G02F 1/133553; G02F 1/1368; G02F 2201/123; G02F 2201/121; G02F 2001/133354

(57) ABSTRACT

In forming of an element substrate of an electro-optical device, after a plurality of films having a film that forms the pixel switching elements on one surface side of the substrate and a film that forms the pixel electrodes are formed, the substrate is removed through polishing and etching, and thus a layered structure is acquired. Subsequently, in pasting, a surface, on which the substrate is located, is pasted to a lens array substrate that is provided with a lens surface and a lens layer, which covers the lens surface, by an adhesive layer in the layered structure such that the pixel electrodes overlap the lens surface in plan view.

### BACKGROUND

### 1. Technical Field

The present invention relates to an electro-optical device, an electronic apparatus, and a method of manufacturing an electro-optical device in which lenses are formed to correspond to pixel electrodes.

### 2. Related Art

In an electro-optical device (liquid crystal apparatus) which is used as a light valve or the like of a projection-type display apparatus, a liquid crystal layer is disposed between an element substrate, on which pixel electrodes and pixel switching elements are formed, and a counter substrate, on which common electrodes are formed. In the electro-optical device, a configuration is proposed in which a plurality of lenses that overlap the plurality of respective pixel electrodes in plan view are formed on the element substrate in order to improve image qualities. In addition, in a case where the lenses are formed on the element substrate, a technology is proposed in which a lens surface, which includes a concave surface, is formed on the substrate, a lens layer is formed on the whole surface thereof, and lenses are formed by flattening the surface of the lens layer (refer to JP-A-2004-258052).

In JP-A-2004-258052, in a case where the flattening is performed, the lens layer remains over the entire one surface of the substrate in addition to the inside of the concave surface. In the configuration, the lens layer is formed on the entire surface of the substrate regardless of a large difference in thickness of the lens layer in an in-plane direction of the substrate. Therefore, in a case where high temperature is applied to the lens layer in a step after forming the lens layer, stress is concentrated on specific spots of the lens layer due to the difference in thickness. For example, in a case in which high temperature is applied to the lens layer in a step of forming a semiconductor layer, which includes polysilicon, of the pixel switching elements and a step of forming a gate electrode through a thermal oxidation method after the lens layer is formed, stress is concentrated on the specific spots of the lens layer due to the difference in thickness. Since the stress causes cracks to be generated in the lens layer, it is not preferable.

### SUMMARY

An advantage of some aspects of the invention is that it provides an electro-optical device, an electronic apparatus, and a method of manufacturing an electro-optical device which are capable of preventing cracks from being generated in a lens layer even in a case where lenses are provided in an element substrate.

According to a first aspect of the invention, there is provided an electro-optical device including: an element substrate that is provided with pixel electrodes and pixel switching elements which are electrically connected to the pixel electrodes; a counter substrate that is provided with common electrodes which face the pixel electrodes; and an electro-optical layer that is provided between the element substrate and the counter substrate, the element substrate includes a lens array substrate that is provided with a first lens surface, which includes a concave surface or a convex surface that overlaps the pixel electrodes, and a first light-transmitting lens layer which covers the first lens surface, and a layered structure that is pasted to one surface side of the lens array substrate through an adhesive layer and that is configured to include a plurality of films having a film which forms the pixel switching elements and a film that forms the pixel electrodes.

According to a second aspect of the invention, there is provided a method of manufacturing an electro-optical device, which includes an element substrate that is provided with pixel electrodes and pixel switching elements which are electrically connected to the pixel electrodes; a counter substrate that is provided with common electrodes which face the pixel electrodes; and an electro-optical layer that is provided between the element substrate and the counter substrate, the method including: forming the element substrate including forming a plurality of films having a film that forms the pixel switching elements on one surface side of the substrate and a film that forms the pixel electrodes; acquiring a layered structure that includes the plurality of films by removing the substrate from another surface side; and pasting a surface, on which the substrate is located, to a lens array substrate that is provided with a first lens surface, which includes a concave surface or a convex surface, and a first light-transmitting lens layer, which covers the first lens surface, in the layered structure such that the pixel electrodes overlap the first lens surface.

According to the aspects of the invention, the layered structure, which includes the plurality of films having the film that forms the pixel switching elements and the film that forms the pixel electrodes, is pasted to the lens array substrate, on which the first lens surface and the first lens layer are provided, through the adhesive layer. Therefore, heat, which is generated in a case where the pixel switching elements are formed, is not added to the first lens layer. Accordingly, it is difficult that large stress is concentrated on specific spots of the first lens layer. Accordingly, it is possible to prevent a problem in that cracks are generated in the first lens layer and a problem in that the first lens layer is peeled off due to the cracks from being generated. In addition, in the aspects of the invention, in a case where the lens array substrate is pasted to the layered structure, the layered structure includes the plurality of films and does not include the substrate. Accordingly, it is possible to prevent the element substrate from being thick.

In the electro-optical device according to the aspect of the invention, it is preferable that the lens array substrate be provided with a light-shield layer that overlaps a semiconductor layer of the pixel switching elements. In the method of manufacturing an electro-optical device, the lens array substrate is provided with a light-shield layer that overlaps a semiconductor layer of the pixel switching elements in plan view in a case where the layered structure is pasted to the lens array substrate. According to the configuration, heat, which is generated in a case where the pixel switching elements are formed, is not added to the light-shield layer. Accordingly, it is possible to prevent the light shielding properties of the light-shield layer from being deteriorated due to heat.

In the electro-optical device and the method of manufacturing an electro-optical device according to the aspects of the invention, it is preferable that the light-shield layer be provided on one surface side that is located on a side of the layered structure of the lens array substrate. According to the configuration, it is possible to cause a gap between the semiconductor layer of the pixel switching elements and the light-shield layer to be narrow. Accordingly, it is possible to effectively shield light, which is incident on the semiconductor layer of the pixel switching elements, by the light-shield layer.

In the electro-optical device and the method of manufacturing an electro-optical device according to the aspects of the invention, the light-shield layer may include a light reflection layer that is located on a side opposite to the layered structure, and an optical absorption layer that is laminated on the light reflection layer on a side of the layered structure. According to the configuration, it is possible to reflect light, which faces the light-shield layer from a side opposite to the counter substrate, on the light reflection layer, and it is possible to absorb light, which faces the light-shield layer from the side of the counter substrate, by the optical absorption layer.

In the electro-optical device according to the aspect of the invention, the layered structure may be provided with a first alignment mark on the same layer as any one of the plurality of films, and the lens array substrate may be provided with a second alignment mark on the same layer as the light-shield layer. In the method of manufacturing an electro-optical device according to the aspect of the invention, the forming of the plurality of films may include forming a first alignment mark by any one of the plurality of films, a second alignment mark on the same layer as the light-shield layer may be formed in the lens array substrate, and the pasting of the surface may include aligning the layered structure with the lens array substrate by the first alignment mark and the second alignment mark. According to the configuration, it is possible to appropriately paste the layered structure to the lens array substrate. In addition, the first alignment mark may be formed on the same layer as any one of the plurality of films and the second alignment mark may be formed on the same layer as the light-shield layer, and thus it is not necessary to add steps in order to form the alignment mark.

In the electro-optical device and the method of manufacturing an electro-optical device according to the aspect of the invention, the lens array substrate may be provided with the first lens surface and the first lens layer on another surface side which is located on a side opposite to the layered structure. According to the configuration, even though the lenses are provided in the element substrate, it is possible to secure a sufficiently long optical path length from the lens surface to the layered structure. Accordingly, it is possible to effectively guide light, which is incident on the element substrate from a side of the lens array substrate, to pixel opening sections.

In the electro-optical device and the method of manufacturing an electro-optical device according to the aspect of the invention, the lens array substrate may be provided with a light-transmitting film on a side of the layered structure rather than the first lens surface and the first lens layer. According to the configuration, even though the lenses are provided in the element substrate, it is possible to secure the sufficiently long optical path length from the lens surface to the layered structure. Accordingly, it is possible to effectively guide light, which is incident on the element substrate from the side of the lens array substrate, to the pixel opening sections.

In the electro-optical device and the method of manufacturing an electro-optical device according to the aspect of the invention, the counter substrate may be provided with a second lens surface, which includes a concave surface or a convex surface that overlaps the pixel electrodes, and a second light-transmitting lens layer which covers the second lens surface.

In the method of manufacturing an electro-optical device according to the aspect of the invention, the forming of the plurality of films may include forming the plurality of films after forming an etching stopper layer on one surface side of the substrate, and the acquiring of the layered structure may include etching the substrate to remove the substrate until reaching at least the etching stopper layer, and removing the etching stopper layer after the etching of the substrate.

An electro-optical device according to the aspect of the invention is used for various electronic apparatuses. For example, the electronic apparatus may include a light source section that causes light to be incident to the element substrate side for the electro-optical device. In addition, among various electronic apparatuses, an electro-optical device is used for a projection-type display apparatus, the projection-type display apparatus is provided with the light source section that emits light which is supplied to the electro-optical device, and a projection optical system that projects light which is modulated by the electro-optical device.

### BRIEF DESCRIPTION OF THE DRAWINGS

The invention will be described with reference to the accompanying drawings, wherein like numbers reference like elements.

FIG. 1 is a plan view illustrating an electro-optical device to which the invention is applied.

FIG. 2 is a sectional view illustrating an electro-optical device according to a first embodiment of the invention.

FIG. 3 is a plan view illustrating a plurality of pixels which are adjacent to each other in the electro-optical device illustrated in FIG. 2.

FIG. 4 is a sectional view illustrating a part of the electro-optical device illustrated in FIG. 2.

FIG. 5 is a sectional view illustrating a light-shield layer of a lens array substrate illustrated in FIG. 2.

FIG. 6 is a sectional view illustrating steps of a method of manufacturing the electro-optical device illustrated in FIG. 2.

FIG. 7 is a sectional view illustrating an electro-optical device according to a second embodiment of the invention.

FIG. 8 is a schematic configuration view illustrating a projection-type display apparatus (electronic apparatus) using the electro-optical device to which the invention is applied.

### DESCRIPTION OF EXEMPLARY EMBODIMENTS

Embodiments of the invention will be described with reference to the accompanying drawings. Meanwhile, in the drawings which are referred to in the description below, each layer and each member are shown at sizes which can be recognized in the drawing, and thus the scales thereof are different for each layer and each member. In addition, in the description below, in a case where a layer which is formed on an element substrate is described, “an upper layer side” or a “surface side” mean a side on which a counter substrate is located, and “a lower layer side” means a side opposite to a side on which the counter substrate is located. In contrast, in a case where a layer which is formed on the counter substrate is described, the “upper layer side” or a “surface side” mean a side on which the element substrate is located, and the “lower layer side” means a side opposite to a side on which the element substrate is located.

### First Embodiment

### Configuration of Electro-Optical Device

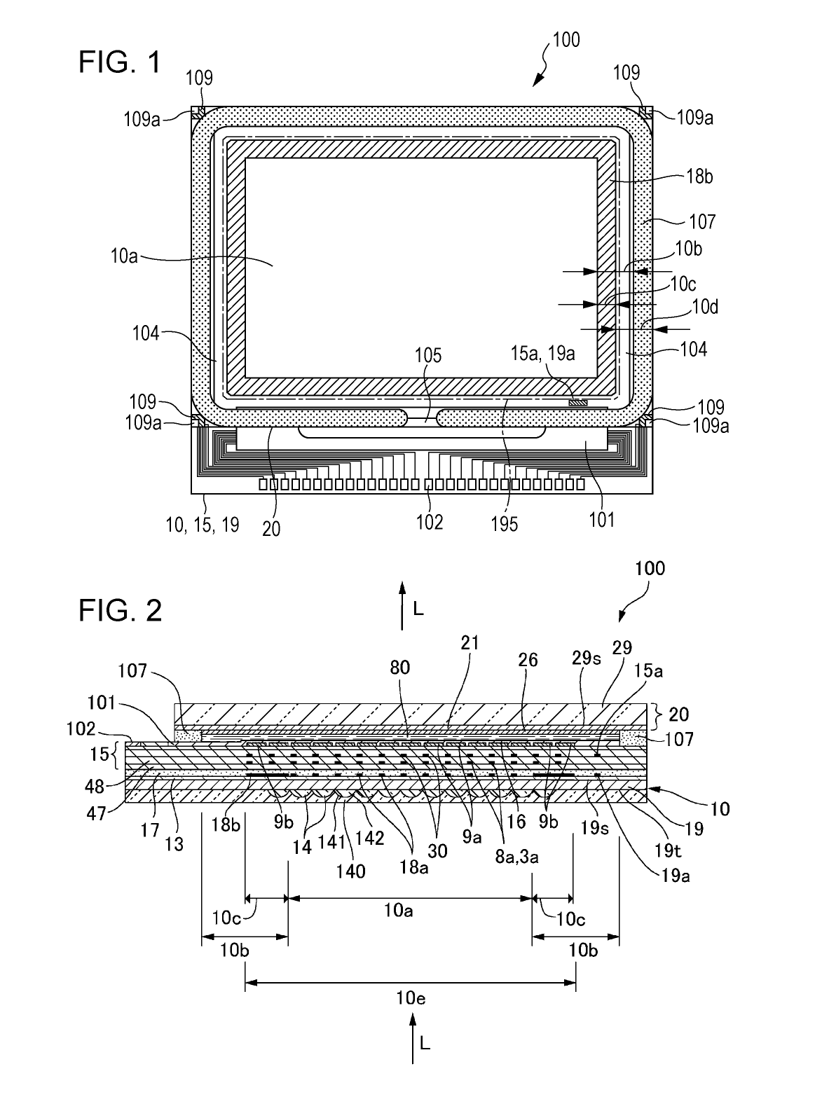

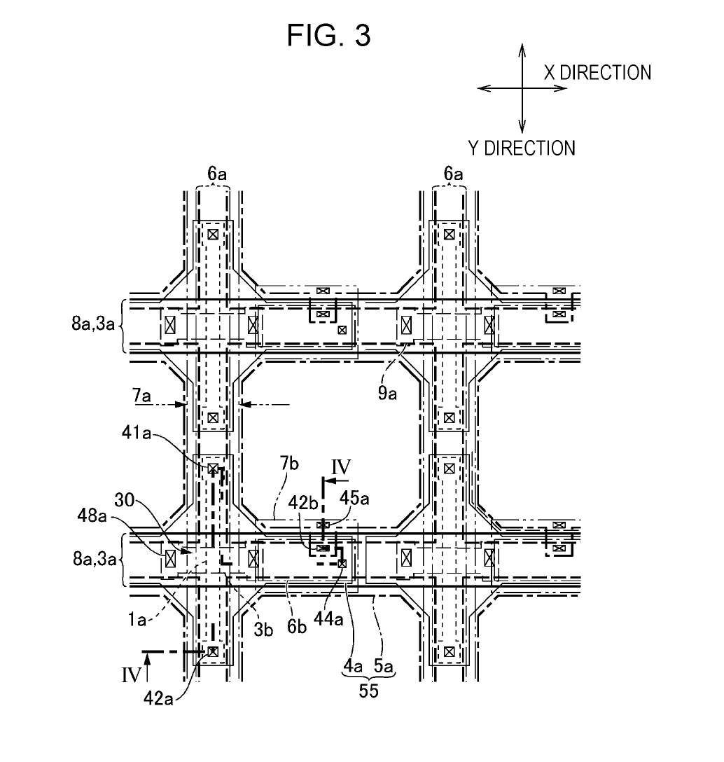

FIG. 1 is a plan view illustrating an electro-optical device 100 to which the invention is applied. FIG. 2 is a sectional view illustrating an electro-optical device 100 according to a first embodiment of the invention. As illustrated in FIGS. 1 and 2, in the electro-optical device 100, an element substrate 10 and a counter substrate 20 are pasted by a seal material 107 with a predetermined gap, and the element substrate 10 faces the counter substrate 20. The seal material 107 is provided in a frame shape along the outer edge of the counter substrate 20, and an electro-optical layer 80, such as a liquid crystal layer, is disposed in an area which is surrounded by the seal material 107 between the element substrate 10 and the counter substrate 20. Accordingly, the electro-optical device 100 is formed as a liquid crystal apparatus. The seal material 107 is a photosetting adhesive or a photosetting and thermosetting adhesive, and contains a gap material, such as glass fibers or glass beads, in order to set a distance between both the substrates to a predetermined value.

Both the element substrate 10 and the counter substrate 20 have a square shape, and a display area 10a is provided at an approximately center of the electro-optical device 100 as a square-shaped area. According to the shape, the seal material 107 is also provided in an approximately square shape, and a rectangular-shaped peripheral area 10b is provided between an inner periphery of the seal material 107 and an outer periphery of the display area 10a.

A data line drive circuit 101 and a plurality of terminals 102 are formed along one side of the element substrate 10 on the outside of the display area 10a on a surface of the element substrate 10 on a side of the counter substrate 20, and a scan line drive circuit 104 is formed along another side which is adjacent to the one side. A flexible wiring substrate (not shown in the drawing) is connected to the terminals 102, and various potentials and various signals are input to the element substrate 10 through the flexible wiring substrate.

A plurality of light-transmitting pixel electrodes 9a, which include Indium Tin Oxide (ITO) films or the like, and pixel switching elements 30, which are electrically connected to the plurality of respective pixel electrodes 9a, are formed in a matrix shape in the display area 10a on the surface of the element substrate 10 on the side of the counter substrate 20. A first oriented film 16 is formed on the pixel electrodes 9a on the side of the counter substrate 20, and the pixel electrodes 9a are covered by the first oriented film 16.

A light-transmitting common electrode 21, which includes an ITO film, is formed on the side of a surface of the counter substrate 20 which faces the element substrate 10, and a second oriented film 26 is formed on the common electrode 21 on the side of the element substrate 10. The common electrode 21 is formed on approximately the entire surface of the counter substrate 20 and is covered by the second oriented film 26.

The first oriented film 16 and the second oriented film 26 are formed of an inorganic oriented film (perpendicular oriented film) that includes a diagonally vapor-deposited film, such as SiOₓ (x<2), SiO₂, TiO₂, MgO, or Al₂O₃, and liquid crystal molecules, which include negative dielectric anisotropy that is used for the electro-optical layer 80, are aligned at an incline. Therefore, the liquid crystal molecules form a predetermined angle for the element substrate 10 and the counter substrate 20. In this manner, the electro-optical device 100 is formed as a liquid crystal apparatus in a Vertical Alignment (VA) mode.

In the element substrate 10, inter-substrate conduction electrodes 109 are formed in areas, which overlap the corner parts of the counter substrate 20 on the outer side of the seal material 107, in order to enable electrical conduction between the element substrate 10 and the counter substrate 20. In the inter-substrate conduction electrodes 109, inter-substrate conduction materials 109a, which include conductive particles, are disposed. The common electrode 21 of the counter substrate 20 is electrically connected to the side of the element substrate 10 via the inter-substrate conduction materials 109a and the inter-substrate conduction electrodes 109. Therefore, a common potential is applied to the common electrode 21 from the side of the element substrate 10.

In the electro-optical device 100 of the embodiment, the pixel electrodes 9a and the common electrodes 21 are formed of an ITO film (light-transmitting conductive film), and the electro-optical device 100 is formed as a transmission-type liquid crystal apparatus. In the electro-optical device 100, light emitted from a light source section is modulated for each pixel by the electro-optical layer 80 while the light is incident on one substrate side of the element substrate 10 and the counter substrate 20 and the light is emitted from another substrate side in an electronic apparatus, such as a projection-type display apparatus, which will be described later, thereby displaying an image. In the embodiment, as illustrated by an arrow L in FIG. 2, light emitted from the light source section is modulated for each pixel by the electro-optical layer 80 while the light is incident on the side of the element substrate 10 and is emitted from the side of the counter substrate 20, thereby displaying an image. In the electro-optical device 100 of the embodiment, a parting 18b, which includes a light-shield layer extending along the outer periphery of the display area 10a, is formed in the element substrate 10, which is located on the side on which light is incident, of the element substrate 10 and the counter substrate 20. In addition, dummy pixel electrodes 9b, which are simultaneously formed with the pixel electrodes 9a, are formed in a dummy pixel area 10c, which overlaps the parting 18b in plan view, in the peripheral area 10b of the element substrate 10.

### Configuration of Plan Surface of Element Substrate 10

FIG. 3 is a plan view illustrating a plurality of pixels which are adjacent to each other in the electro-optical device 100 illustrated in FIG. 2. Meanwhile, in FIG. 3, respective layers are indicated by the lines described below. In addition, in FIG. 3, with regard to layers which have terminals overlapping each other in plan view, the positions of the terminals are shifted such that the shapes or the like of the layers are easily understood.

Thick solid line denotes a scan line 3a (lower layer side light-shield layer 8a).

Thin and short dotted line denotes a semiconductor layer 1a.

Thin and long broken line denotes a gate electrode 3b.

Thin solid line denotes a drain electrode 4a.

Thin one-dot chain line denotes a data line 6a and a relay electrode 6b.

Thick one-dot chain line denotes a capacitance line 5a.

Thin two-dot chain line denotes an upper layer side light-shield layer 7a and a relay electrode 7b.

Thick broken line denotes the pixel electrode 9a.

As illustrated in FIG. 3, the pixel electrodes 9a are formed in the plurality of respective pixels on the surface of the element substrate 10, which faces the counter substrate 20, and the data lines 6a and the scan lines 3a are formed along inter pixel areas interposed by the adjacent pixel electrodes 9a. The inter-pixel areas extend horizontally and vertically, the scan lines 3a extend linearly along a first inter-pixel area of the inter-pixel areas, which extends in the X direction, and the data lines 6a extend linearly along a second inter-pixel area which extends in the Y direction. In addition, the pixel switching elements 30 are formed to correspond to the intersections of the data lines 6a and the scan lines 3a. In the embodiment, the pixel switching elements 30 are formed using intersection areas between the data lines 6a and the scan lines 3a and the vicinity thereof. In the element substrate 10, a capacitance line 5a, and a common potential Vcom is applied to the capacitance line 5a. The capacitance line 5a extends to overlap the scan lines 3a and the data lines 6a and is formed in a lattice shape. The upper layer side light-shield layer 7a is formed on the upper layer side of the pixel switching elements 30, and the upper layer side light-shield layer 7a extends to overlap the data lines 6a. The lower layer side light-shield layer 8a is formed on a lower layer side of the pixel switching elements 30, and the lower layer side light-shield layer 8a extends in an X direction as the scan lines 3a.

### Sectional Configuration of Element Substrate 10

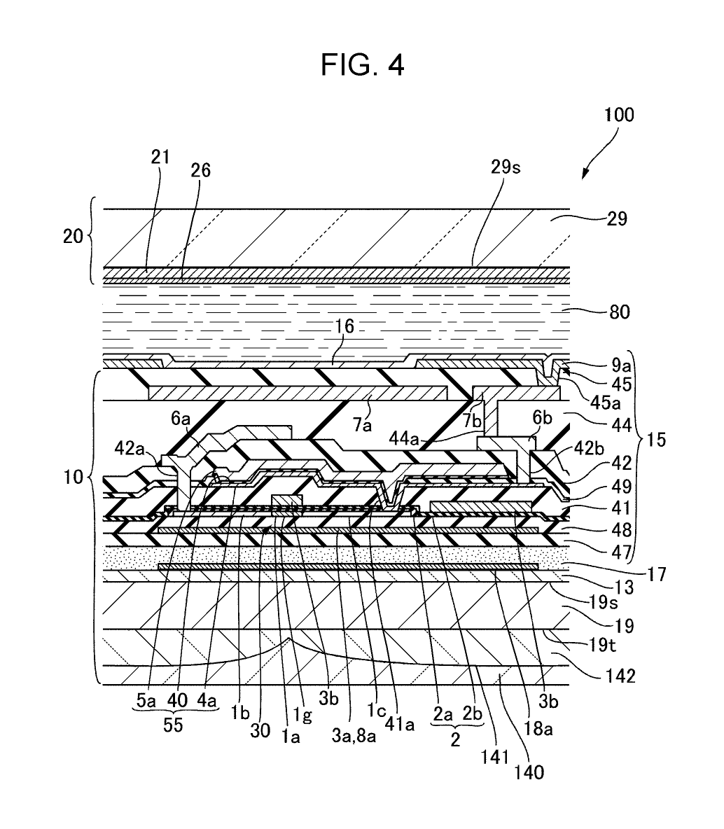

FIG. 4 is a sectional view illustrating a part of the electro-optical device 100 illustrated in FIG. 2, and is a sectional view taken along line IV-IV of FIG. 3. As illustrated in FIGS. 2 and 4, the element substrate 10 includes a lens array substrate 19 and a layered structure 15 which is pasted to one surface 19s of the lens array substrate 19 through an adhesive layer 17. The lens array substrate 19 is provided with a lens surface 141 (first lens surface), which includes a concave surface or a convex surface that overlaps the pixel electrodes 9a in plan view viewed from a direction perpendicular to a plane of the element substrate 10, and is a light-transmitting lens layer 140 (first lens layer) that covers the lens surface 141. The layered structure 15 includes a plurality of films which include a film that forms the pixel switching element 30 and a film that forms the pixel electrodes 9a, as will be described below.

The layered structure 15 includes a protective film 47, which includes a silicon oxide film, on a side of the lens array substrate 19, and the lower layer side light-shield layer 8a, which includes a conductive film such as a conductive polysilicon film, a metal silicide film, a metal film or a metal compound film, is formed on an upper layer of the protective film 47. In the embodiment, the lower layer side light-shield layer 8a is formed of a light-shield film, such as tungsten silicide (WSi), tungsten, or titanium nitride, and prevents a malfunction from being generated which is caused by photoelectric current in the pixel switching elements 30 in a case where light, which is incident on the side of the element substrate 10, is incident on the semiconductor layer 1a of the pixel switching elements 30. In the embodiment, the lower layer side light-shield layer 8a is formed as the scan line 3a. The scan line 3a is electrically connected to the gate electrode 3b, which will be described later, via the contact hole 48a.

A light-transmitting insulation film 48, which includes a silicon oxide film, is formed on the upper layer side of the lower layer side light-shield layer 8a, and the pixel switching element 30, which includes the semiconductor layer 1a, is formed on the upper layer side of the insulation film 48. The pixel switching element 30 includes the semiconductor layer 1a and the gate electrode 3b which extends in a direction orthogonal to the longitudinal direction of the semiconductor layer 1a and overlaps a central part of the longitudinal direction of the semiconductor layer 1a. The pixel switching element 30 includes a light-transmitting gate insulation layer 2 between the semiconductor layer 1a and the gate electrode 3b. The semiconductor layer 1a includes a channel area 1g, which faces the gate electrode 3b through the gate insulation layer 2, and includes a source area 1b and a drain area 1c on both sides of the channel area 1g. In the embodiment, the pixel switching element 30 has an LDD structure. Accordingly, the source area 1b and the drain area 1c respectively include low concentration areas on both sides of the channel area 1g and include high-concentration areas in areas which are adjacent to the channel area 1g on a side opposite to the low concentration areas.

The semiconductor layer 1a is formed of a polysilicon film (polycrystalline silicon film) or the like. The gate insulation layer 2 includes a two-layered structure which includes a first gate insulation layer 2a that includes a silicon oxide film acquired by performing thermal oxidation on the semiconductor layer 1a, and a second gate insulation layer 2b that includes a silicon oxide film formed by a decompression CVD method or the like. The gate electrode 3b and the scan line 3a include a conductive film such as a conductive polysilicon film, a metal silicide film, a metal film, or a metal compound film.

A light-transmitting inter-layer insulation film 41, which includes the silicon oxide film, is formed on the upper layer side of the gate electrode 3b, and the drain electrode 4a is formed on an upper layer of the inter-layer insulation film 41. The drain electrode 4a includes a conductive film such as a conductive polysilicon film, a metal silicide film, a metal film, or a metal compound film. The drain electrode 4a is formed such that a part of the drain electrode 4a overlaps the drain area 1c of the semiconductor layer 1a and the drain electrode 4a is electrically connected to the drain area 1c through a contact hole 41a which passes through the inter-layer insulation film 41 and the gate insulation layer 2.

An insulation film 49 for a light-transmitting etching stopper, which includes the silicon oxide film, and a light-transmitting dielectric layer 40 are formed on the upper layer side of the drain electrode 4a, and the capacitance line 5a is formed on the upper layer side of the dielectric layer 40. It is possible to use silicon compounds, such as a silicon oxide film and a silicon nitride film, as the dielectric layer 40. In addition, it is possible to use a dielectric layer, such as an aluminum oxide film, a titanium oxide film, a tantalum oxide film, a niobium oxide film, a hafnium oxide film, a lanthanum oxide film, or a zirconium oxide film, which has a high dielectric constant. The capacitance line 5a includes a conductive film, such as an electrically conductive polysilicon film, a metal silicide film, a metal film, or a metal compound film. The capacitance line 5a overlaps the drain electrode 4a through the dielectric layer 40, and forms a holding capacitor 55.

A light-transmitting inter-layer insulation film 42, which includes a silicon oxide film or the like, is formed on the upper layer side of the capacitance line 5a, and the data lines 6a and the relay electrodes 6b are formed by the same conductive film on the upper layer side of the inter-layer insulation film 42. The data lines 6a extend linearly along the inter pixel areas which extend in an Y direction illustrated in FIG. 3, of the inter pixel areas, and each of the pixel switching elements 30 is provided to correspond to intersections between the data lines 6a and the scan lines 3a.

The data line 6a and the relay electrode 6b include a conductive film such as a conductive polysilicon film, a metal silicide film, a metal film or a metal compound film. The data line 6a is electrically connected to the source area 1b through the contact hole 42a which passes through the inter-layer insulation film 42, the insulation film 49, the inter-layer insulation film 41, and the gate insulation layer 2. The relay electrode 6b is electrically connected to the drain electrode 4a through the contact hole 42b which passes through the inter-layer insulation film 42 and the insulation film 49.

A light-transmitting inter-layer insulation film 44, which includes a silicon oxide film, is formed on the upper layer side of the data line 6a and the relay electrode 6b, and the upper layer side light-shield layer 7a and the relay electrode 7b are formed by the same conductive film on the upper layer side of the inter-layer insulation film 44. A surface of the inter-layer insulation film 44 is flattened. The upper layer side light-shield layer 7a and the relay electrode 7b include a conductive film such as a conductive polysilicon film, a metal silicide film, a metal film, or a metal compound film. The relay electrode 7b is electrically connected to the relay electrode 6b through a contact hole 44a which passes through the inter-layer insulation film 44. The upper layer side light-shield layer 7a extends to overlap the data line 6a, and functions as the light-shield layer. Meanwhile, the upper layer side light-shield layer 7a may be used as a shield layer through electrical conduction with the capacitance line 5a.

A light-transmitting inter-layer insulation film 45, which includes a silicon oxide film, is formed on the upper layer side of the upper layer side light-shield layer 7a and the relay electrode 7b, and the pixel electrode 9a, which includes an ITO film or the like, is formed on the upper layer side of the inter-layer insulation film 45. The contact hole 45a, which reaches the relay electrode 7b, is formed in the inter-layer insulation film 45, and the pixel electrode 9a is electrically connected to the relay electrode 7b through the contact hole 45a. As a result, pixel electrode 9a is electrically connected to the drain area 1c through the relay electrode 7b, the relay electrode 6b, and the drain electrode 4a. The surface of the inter-layer insulation film 45 is flattened. The first light-transmitting oriented film 16, which includes a polyimide or an inorganic oriented film, is formed on the surface side of the pixel electrode 9a.

### Configuration of Lens Array Substrate 19

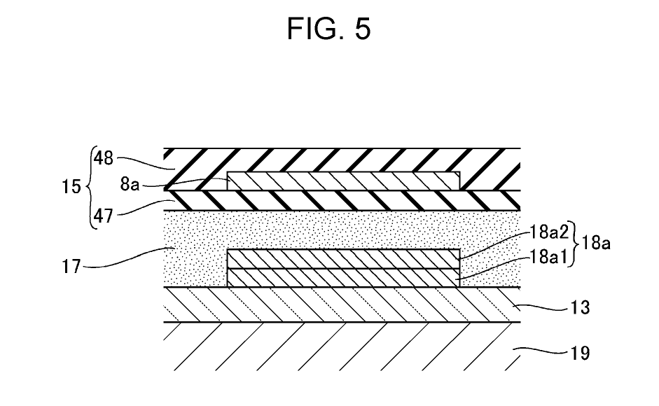

FIG. 5 is a sectional view illustrating a light-shield layer 18a of the lens array substrate 19 illustrated in FIG. 2. In the element substrate 10, which is described with reference to FIGS. 2 to 4, the light-shield layer, which includes the data line 6a and the like, and the pixel switching elements 30 are formed, and the light-shield layer and the pixel switching elements 30 do not transmit light. Therefore, in the element substrate 10, in the areas which overlap the pixel electrodes 9a in plan view, areas, which overlap the light-shield layers and the pixel switching elements 30 in plan view, and areas, which overlap areas interposed between adjacent pixel electrodes 9a, become light-shield areas which do not transmit light. In contrast, in the areas which overlap the pixel electrodes 9a in plan view, areas, which do not overlap the light-shield layers and the pixel switching elements 30 in plan view, become pixel opening areas (light-transmitting area) which transmit light. Accordingly, only light which passes through the opening areas contributes to display of an image, and light which faces the light-shield areas does not contribute to display of the image.

Here, in the element substrate 10, the lens array substrate 19 is used, and a plurality of lenses 14, which respectively overlap the plurality of pixel electrodes 9a in plan view with one-to-one relationship, are formed in the lens array substrate 19. The lenses 14 guide light to the pixel opening areas.

In a case where the lens array substrate 19 is formed, a plurality of lens surfaces 141, which include convex surfaces that respectively overlap the plurality of pixel electrodes 9a in plan view with one-to-one relationship, are formed on another surface 19t of the lens array substrate 19. In addition, the lens layer 140 is formed to cover the lens surfaces 141 on the side of another surface 19t of the lens array substrate 19. A hemispherical convex section 142, which forms the lens surface 141, has a different refractive index from the lens layer 140, lens surface 141, and the lens layer 140 forms the lenses 14. In the embodiment, the refractive index of the convex section 142 is larger than the refractive index of the lens layer 140. For example, the lens layer 140 is formed of silicon oxide (SiO₂) and has a refractive index of 1.48. In contrast, the convex section 142 includes a silicon oxynitride film (SiON) and has a refractive index of 1.58 to 1.68. Therefore, the lenses 14 have power to converge light from light sources.

In a case where the convex section 142 (lens surface 141) is formed, the silicon oxynitride film is formed on another surface 19t of the lens array substrate 19, a hemispherical resin convex section 142 is formed, thereafter, the convex section and the silicon oxynitride film are etched through dry etching using an Inductively Coupled Plasma (ICP) apparatus or the like, and the convex section 142 (lens surface 141) is formed. Meanwhile, after for example, a positive type photosensitive resin is applied, the photosensitive resin is exposed using a gray scale mask or the like, and, thereafter, the resin convex section 142 is developed.

The light-shield layer 18a, which overlaps the semiconductor layer 1a of the pixel switching elements 30 in plan view, is provided in the lens array substrate 19. In the embodiment, the light-shield layer 18a is provided on one surface 19s of the lens array substrate 19 on a side of the layered structure 15. In the embodiment, the parting 18b, which is described with reference to FIGS. 1 and 2, includes, for example, a light-shield film on a layer which is the same as the light-shield layer 18a. In the lens array substrate 19, a light-transmitting film 13, which includes a silicon oxide film or the like and adjusts an optical path length, is provided on a side of the layered structure 15 rather than the lens surface 141 and the lens layer 140. In the embodiment, the light-transmitting film 13 is provided between the lens array substrate 19 and the light-shield layer 18a.

In the embodiment, as illustrated in FIG. 5, the light-shield layer 18a has a two-layer structure of a light reflection layer 18a1, which is located on a side (light incident side) opposite to the layered structure 15, and an optical absorption layer 18a2 which is laminated on the light reflection layer 18a1 on a side of the layered structure 15. Accordingly, it is possible to reflect light, which faces the light-shield layer 18a from a side opposite to the counter substrate 20, on the light reflection layer 18a1, and it is possible to absorb light, which faces the light-shield layer 18a from the side of the counter substrate 20, by the optical absorption layer 18a2. In the embodiment, the light reflection layer 18a1 includes, for example, an aluminum layer, and the optical absorption layer 18a2 includes a titanium layer, a titanium nitride layer, a tungsten layer, a tungsten silicide layer, a chrome layer, a molybdenum layer, or the like.

Furthermore, in FIGS. 2 and 4, in the layered structure 15, a first alignment mark 15a are formed on the same layer as any one of the plurality of films which are formed in the layered structure 15. In contrast, in the lens array substrate 19, a second alignment mark 19a is provided on the same layer as the light-shield layer 18a in a position which overlaps the first alignment mark 15a in plan view.

### Configuration of Counter Substrate 20

In the counter substrate 20, a light-shield layer 27, a protective layer 28, which includes a silicon oxide film or the like, and the common electrode 21, which includes the light-transmitting conductive film such as an ITO film, are formed on a surface (one surface 29s which faces the element substrate 10) on a side of the electro-optical layer 80 of a light-transmitting substrate 29 (light-transmitting substrate) such as a quartz substrate and a glass substrate, and a second light-transmitting oriented film 26, which includes a polyimide or an inorganic oriented film, is formed to cover the common electrode 21. In the embodiment, the common electrode 21 includes the ITO film.

### Method of Manufacturing Electro-Optical Device 100

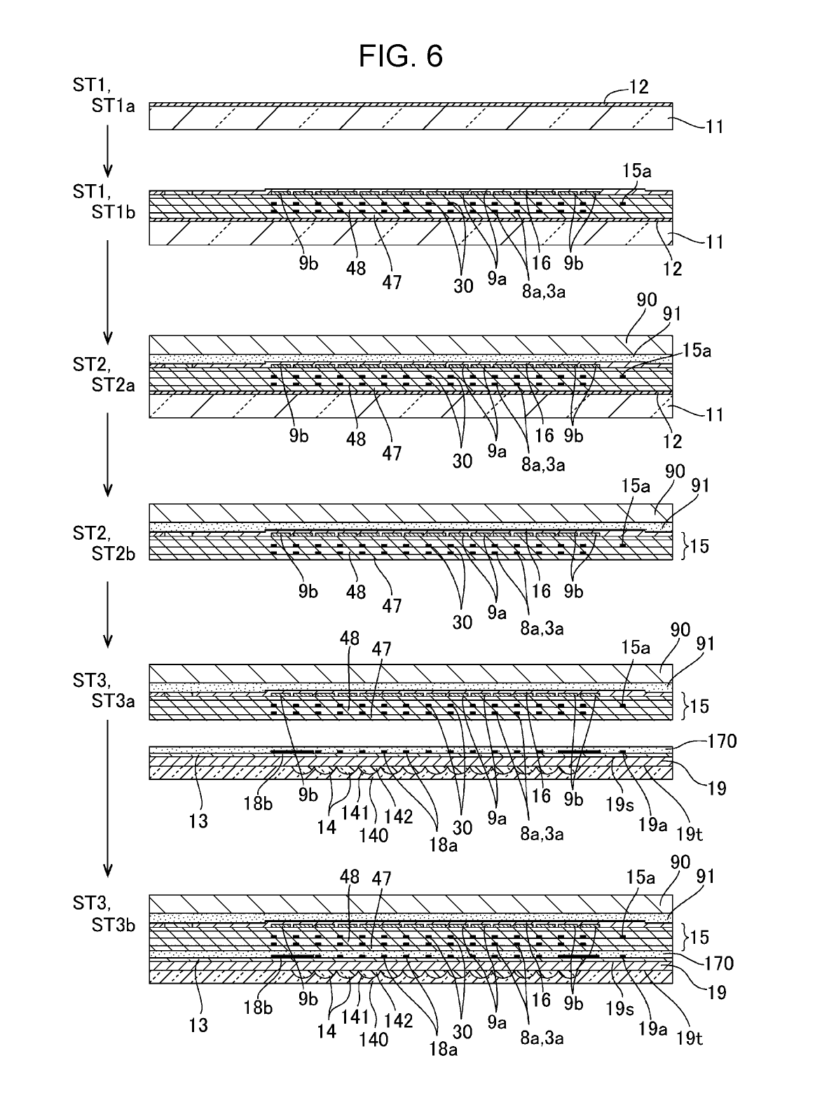

FIG. 6 is a sectional view illustrating steps of a method of manufacturing the electro-optical device 100 illustrated in FIG. 2. In FIG. 6, up and down directions correspond to directions illustrated in FIG. 2, and, in each step, there is a case where the step is performed while the up and down directions are reversed. In the method of manufacturing the electro-optical device 100 according to the embodiment, a mother substrate, which is larger than the substrate 11 and the lens array substrate 19 in a single size, is used in a step of manufacturing the element substrate 10. However, in the description below, the substrate 11, the element substrate 10, and the lens array substrate 19 will be described regardless of the single size and the mother substrate.

In the step of manufacturing the element substrate 10 according to the embodiment, the following steps are performed.

Element forming step ST1

First substrate removing step ST2

Pasting step ST3

In an element forming step ST1, on the side of one surface 11s of the substrate 11, the plurality of films having the film, which forms the pixel switching elements 30, and the film, which forms the pixel electrodes 9a, are formed. More specifically, first, in an etching stopper forming step ST1a, an etching stopper layer 12 is formed on the entire surface of one surface 11s of the substrate 11. The etching stopper layer 12 includes a poly silicon film and a tungsten silicide film. Subsequently, in a laminating step ST1b, the protective film 47, the lower layer side light-shield layer 8a, the insulation film 48, the pixel switching element 30, the holding capacitor 55, the data line 6a, the pixel electrode 9a, the first oriented film 16, and the like, which are described with reference to FIG. 4, are sequentially formed on an upper layer side of the etching stopper layer 12.

Subsequently, in a first substrate removing step ST2, the layered structure 15, which includes the plurality of films, is acquired by removing the substrate 11 from the side of another surface 11t. More specifically, in a support substrate pasting step ST2a, after the support substrate 90 is pasted to one surface 11s of the substrate 11 through the adhesive layer 91, the substrate 11 is removed by a polishing process and an etching process in a removing step ST2b. In the embodiment, after polishing is performed on the side of another surface 11t of the substrate 11 by a rough polishing and a mechanical polishing, a flattening step, such as a Chemical Mechanical Polishing (CMP) process, is performed. Subsequently, an etching step of etching the substrate 11 until the etching stopper layer 12 is exposed due to a hydrofluoric acid-containing etching liquid is performed using a spin etcher or the like, and the substrate 11 is completely removed. Subsequently, the etching stopper layer 12 is removed by a dry etching process or a CMP process.

Subsequently, in a pasting step ST3, a surface of the layered structure 15 on a side in which the substrate 11 is located is pasted to one surface 19s of the lens array substrate 19 through the adhesive layer 17, such as an adhesive 170. More specifically, in an aligning step ST3a, positions of the lens array substrate 19 and the layered structure 15 are aligned such that the pixel electrodes 9a and the lens surface 141 overlap the lens array substrate 19 and the layered structure 15 in plan view and the semiconductor layer 1a of the pixel switching elements 30 overlaps the lens array substrate 19 and the layered structure 15 in plan view. In the embodiment, the first alignment mark 15a, which is on the same layer as the data line 6a or the like, is formed in the layered structure 15, and the second alignment mark 19a, which is on the same layer as the light-shield layer 18a, is formed on the lens array substrate 19. Therefore, the lens array substrate 19 and the layered structure 15 are aligned based on the first alignment mark 15a and the second alignment mark 19a. Here, the adhesive 170 is applied to at least one of the lens array substrate 19 and the layered structure 15. For example, the adhesive 170 is applied to one surface 19s of the lens array substrate 19 (side on which the light-shield layer 18a is formed). Furthermore, in an adhering step ST3b, the lens array substrate 19 and the layered structure 15 overlap each other while interposing the adhesive 170, and thereafter, an adhesive 170 is solidified. In this step, a state in which the support substrate 90, the layered structure 15, and the lens array substrate 19 are pasted is generated. Subsequently, the support substrate 90 is removed. As a result, the element substrate 10, in which the layered structure 15 is pasted to one surface 19s of the lens array substrate 19 through the adhesive layer 17, is acquired.

Thereafter, as illustrated in FIGS. 1 and 2, the element substrate 10 is pasted to the counter substrate 20 by the seal material 107, and, thereafter, the electro-optical layer 80 is injected between the element substrate 10 and the counter substrate 20.

### Main Advantage of Embodiment

As described above, in the element substrate 10, which is used for the electro-optical device 100 according to the embodiment, the layered structure 15, which includes the plurality of films having the film which forms the pixel switching elements 30 and the film which forms the pixel electrodes 9a, is pasted to the lens array substrate 19, on which the lens surface 141 and the lens layer 140 are provided, through the adhesive layer 17. Therefore, heat generated when the semiconductor layer 1a of the pixel switching elements 30 is formed, and heat generated when the gate insulation layer 2 is formed are not added to the lens layer 140. Accordingly, even in a condition in which a difference in thickness of the lens layer 140 is large in an in-plane direction, it is possible to prevent a situation in which stress is concentrated on specific spots of the lens layer 140 due to the difference in thickness. Therefore, it is possible to prevent a problem, in which cracks are generated in the lens layer 140, and a problem, in which the lens layer 140 is peeled of due to the cracks, from being generated. In addition, in a case where the lens array substrate 19 is pasted to the layered structure 15, the layered structure 15 includes the plurality of films and does not include the substrate 11. Accordingly, it is possible to prevent the element substrate 10 from being thick.

In addition, although light from the light source section is incident on the side of the element substrate 10 in the electro-optical device 100, the light-shield layer 18a, which overlaps the semiconductor layer 1a of the pixel switching elements 30 in plan view, is provided in the element substrate 10. Therefore, light from the light source section is not incident on the semiconductor layer 1a of the pixel switching elements 30, and thus a malfunction of the pixel switching elements 30 caused by photoelectric current is hardly generated. In addition, the lens surface 141 is formed on the side of the element substrate 10. Therefore, in a state in which an optical compensation element, such as an O plate or a C plate, is provided in the counter substrate 20 on a side opposite to the element substrate 10 and the electro-optical layer 80, a structure, such as the wirings which surround the lenses 14 and the pixel opening sections, does not exist between the electro-optical layer 80 and the optical compensation element. Accordingly, a situation, in which advantage attributable to the optical compensation element is obstructed by the structure, such as the wirings which surround the lenses 14 and the pixel opening sections, is hardly generated. Therefore, deterioration in image contrast is hardly generated.

In addition, since the light-shield layer 18a is provided in the lens array substrate 19, heat, which is generated in a case where the pixel switching elements 30 are formed, is not added to the light-shield layer 18a. Accordingly, it is possible to prevent light shielding properties of the light-shield layer 18a from being deteriorated due to heat. For example, in a case where tungsten silicide or the like is used for the lower layer side light-shield layer 8a, the light shielding properties are deteriorated due to heat which is generated in a case where the pixel switching elements 30 or the like are formed in the lower layer side light-shield layer 8a. However, in the light-shield layer 18a which is provided in the lens array substrate 19, heat is not added in the case where the pixel switching elements 30 or the like are formed. Therefore, the light shielding properties are not deteriorated. In addition, the light-shield layer 18a is provided on one surface 19s of the lens array substrate 19 which is located on the side of the layered structure 15. Therefore, it is possible to cause a gap between the semiconductor layer 1a of the pixel switching elements 30 and the light-shield layer 18a to be narrow. Accordingly, it is possible to effectively shield light, which is incident on the semiconductor layer 1a of the pixel switching elements 30, by the light-shield layer 18a.

In addition, the first alignment mark 15a which is on the same layer as the data line 6a or the like is provided in the layered structure 15, the second alignment mark 19a, which is on the same layer as the light-shield layer 18a, is provided in the lens array substrate 19, and thus it is possible to align the layered structure 15 and the lens array substrate 19 by the first alignment mark 15a and the second alignment mark 19a. Therefore, it is possible to appropriately past the layered structure 15 to the lens array substrate 19. In addition, the first alignment mark 15a may be simultaneously formed with the data line 6a or the like and the second alignment mark 19a may be simultaneously formed with the light-shield layer 18a, and thus it is not necessary to add steps in order to form the alignment mark.

In addition, in the lens array substrate 19, the lens surface 141 and the lens layer 140 are provided on another surface 19t which is located on a side opposite to the layered structure 15. Therefore, even though the lens surface 141 is provided in the element substrate 10, it is possible to secure a sufficiently long optical path length from the lens surface 141 to the layered structure 15. Accordingly, it is possible to effectively guide light, which is incident on the element substrate 10 from the side of the lens array substrate 19, to the pixel opening sections. In addition, in the element substrate 10, the light-transmitting film 13 for adjusting the optical path length is provided in the lens array substrate 19 on the side of the layered structure 15 rather than the lens surface 141 and the lens layer 140. Therefore, even in a case where the lens surface 141 is provided in the element substrate 10, it is possible to secure the sufficiently long optical path length from the lens surface 141 to the layered structure 15. Accordingly, it is possible to effectively guide light, which is incident on the element substrate 10 from the side of the lens array substrate 19, to the pixel opening sections.

In addition, in a case where the element substrate 10 is manufactured, the etching stopper layer 12 is formed on the side of one surface 11s of the substrate 11, and the substrate 11 is removed through etching until reaching the etching stopper layer 12. Accordingly, it is easy to control end point of the etching, and thus it is possible to prevent excessive etching.

### Second Embodiment

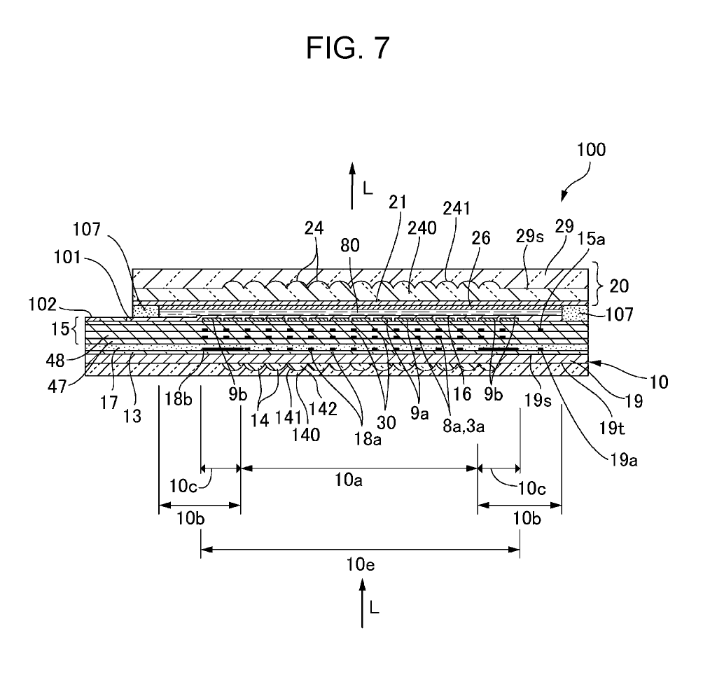

FIG. 7 is a sectional view illustrating an electro-optical device 100 according to a second embodiment of the invention. Meanwhile, since basic configurations of the embodiment are the same as in the first embodiment, common parts are illustrated using the same numerical symbols and the description thereof will not be repeated. In the first embodiment, the lenses 14 are formed only on the side of the element substrate 10. However, as illustrated in FIG. 7, lenses 24 may be formed on the side of the counter substrate 20. That is, the counter substrate 20 includes the substrate 29, on which a lens surface 241 (second lens surface) that includes a concave surface or a convex surface which overlaps the pixel electrodes 9a in plan view, is formed, and a light-transmitting lens layer 240 (second lens layer) which covers the lens surface 241 is provided in the substrate 29. In the embodiment, the lens surface 241, which includes a concave surface, is formed on one surface 29s of the substrate 29, and the lens layer 240 includes the silicon oxynitride film which has a larger refractive index than the substrate 29.

According to the configuration, it is possible to cause light emitted from the counter substrate 20 to be parallel light by the lenses 24, and thus it is possible to improve image qualities.

### Another Embodiment

In the embodiment, the lens surface 141, which includes the convex surface, is formed on the side of another surface 19t of the lens array substrate 19. However, the lens surface 241, which includes the concave surface, may be formed on one surface 19s of the lens array substrate 19, and the lens layer 240 (second lens layer), which includes the silicon oxynitride film, may be formed to cover the lens surface 241. With regard to the lens surface 241, for example, after the etching mask is formed on one surface 29s of the substrate 29, isotropic etching is performed from opening sections of the etching mask, thereby forming the lens surface 241 which includes the concave surface.

In the embodiment, the invention is applied to the electro-optical device 100 in a type in which light is incident on the side of the element substrate 10. However, the invention may be applied to an electro-optical device 100 in a type in which light is incident on the side of the counter substrate 20. In this case, the lenses 24 of the counter substrate 20 guide light to the pixel opening sections, and a part of light emitted from the element substrate 10 to be parallel light by the lenses 14 of the element substrate 10 (lens array substrate 19). In addition, it is possible to prevent light, which is emitted from the side of the element substrate 10, from being reflected on another member and being incident on the semiconductor layer 1a of the pixel switching elements 30 by the light-shield layer 18a which is formed in the lens array substrate 19. In this case, the parting 18b illustrated in FIGS. 1 and 2 is provided on the side of the counter substrate 20. In addition, it is preferable to form the light-shield layer in a black matrix or the like in an area, which overlaps the pixel electrodes 9a in plan view, in the counter substrate 20.

### Mounting Example on Electronic Apparatus

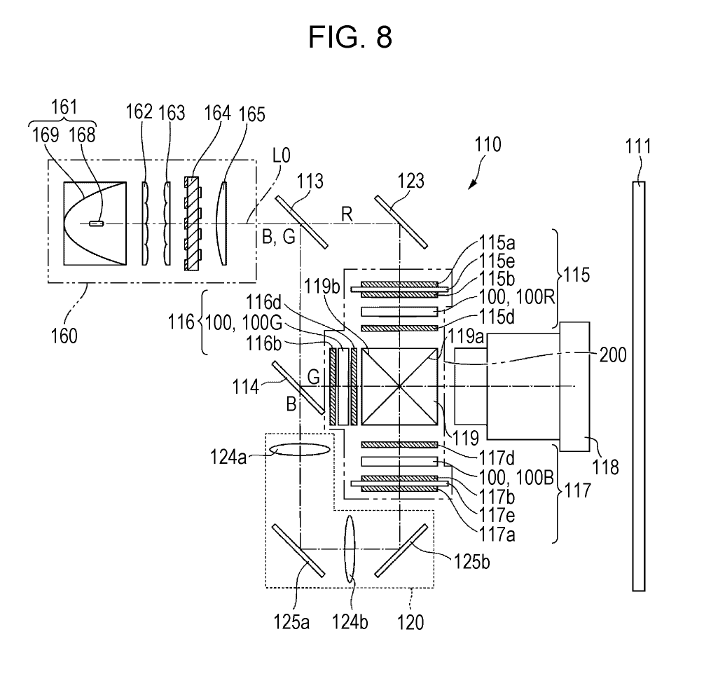

FIG. 8 is a schematic configuration view illustrating a projection-type display apparatus (electronic apparatus) using the electro-optical device 100 to which the invention is applied. Meanwhile, in the description below, a plurality of electro-optical devices 100, to which light having different wavelength areas is supplied, are used. However, the electro-optical device 100 to which the invention is applied is used for all the electro-optical devices 100.

The projection-type display apparatus 110 illustrated in FIG. 8 is a liquid crystal projector using the transmission-type electro-optical device 100, and displays an image by irradiating light to a projection member 111 which includes a screen or the like. The projection-type display apparatus 110 includes, along an optical axis L0 of the apparatus, a lighting device 160, a plurality of electro-optical devices 100 (liquid crystal light valves 115 to 117) to which light emitted from the lighting device 160 is supplied, a cross dichroic prism 119 (photosynthetic optical system) which synthesizes and emits light that is emitted from the plurality of electro-optical devices 100, and a projection optical system 118 which projects light synthesized by the cross dichroic prism 119. In addition, the projection-type display apparatus 110 includes dichroic mirrors 113 and 114, and a relay system 120. In the projection-type display apparatus 110, the electro-optical device 100 and the cross dichroic prism 119 form an optical unit 200.

In the lighting device 160, along the optical axis L0 of the apparatus, a light source section 161, a first integrator lens 162, which includes a lens array such as a fly-eye lens, a second integrator lens 163, which includes a lens array such as a fly-eye lens, a polarized light conversion element 164, and a condenser lens 165 are sequentially disposed. The light source section 161 includes a light source 168 which emits white light including red light R, green light G and blue light B, and a reflector 169. The light source 168 is formed of an extra-high pressure mercury lamp or the like, and the reflector 169 includes a parabolic cross section. The first integrator lens 162 and the second integrator lens 163 equalize the luminance distribution of light emitted from the light source section 161. The polarized light conversion element 164 causes light emitted from the light source section 161 to be polarized light which has a specific vibration direction similar to, for example, s-polarized light.

A dichroic mirror 113 causes red light R, which is included in light emitted from the lighting device 160, to pass therethrough, and reflects green light G and blue light B. A dichroic mirror 114 causes blue light B of green light G and blue light B, which are reflected in the dichroic mirror 113, to pass therethrough, and reflects green light G. As above, the dichroic mirrors 113 and 114 form a color separation optical system which separates light emitted from the lighting device 160 into red light R, green light G, and blue light B.

A liquid crystal light valve 115 is a transmission-type display apparatus that modulates red light R, which passes through the dichroic mirror 113 and is reflected in a reflection mirror 123, according to an image signal. The liquid crystal light valve 115 includes a λ/2 phase difference plate 115a, a first polarizing plate 115b, an electro-optical device 100 (red electro-optical device 100R), and a second polarizing plate 115d. Here, even in a case where red light R, which is incident on the liquid crystal light valve 115, passes through the dichroic mirror 113, polarized light is not changed, and thus s-polarized light is not changed.

The λ/2 phase difference plate 115a is an optical element that converts s-polarized light which is incident on the liquid crystal light valve 115 into p-polarized light. The first polarizing plate 115b is a polarizing plate that cuts off s-polarized light and causes p-polarized light to pass therethrough. The electro-optical device 100 (red electro-optical device 100R) is formed to convert p-polarized light into s-polarized light (in a case of halftone, circularly polarized light or elliptically polarized light) through modulation according to the image signal. The second polarizing plate 115d is a polarizing plate that cuts off p-polarized light and causes s-polarized light to pass therethrough. Accordingly, the liquid crystal light valve 115 modulates red light R according to the image signal, and emits modulated red light R toward the cross dichroic prism 119. The λ/2 phase difference plate 115a and the first polarizing plate 115b are disposed in a state in which the λ/2 phase difference plate 115a and the first polarizing plate 115b come into contact with a light-transmitting glass plate 115e which does not convert polarized light, and it is possible to prevent distortion of the λ/2 phase difference plate 115a and the first polarizing plate 115b due to the generation of heat.

A liquid crystal light valve 116 is a transmission-type display apparatus that modulates green light G, which is reflected in the dichroic mirror 114 after being reflected in the dichroic mirror 113, according to the image signal. The liquid crystal light valve 116 includes a first polarizing plate 116b, an electro-optical device 100 (green electro-optical device 100G), and a second polarizing plate 116d, similar to the liquid crystal light valve 115. Green light G, which is incident on the liquid crystal light valve 116, is s-polarized light which is reflected in and incident into the dichroic mirrors 113 and 114. The first polarizing plate 116b is a polarizing plate that cuts off p-polarized light and causes s-polarized light to pass therethrough. The electro-optical device 100 (green electro-optical device 100G) is formed to convert s-polarized light into p-polarized light (in a case of halftone, circularly polarized light or elliptically polarized light) through modulation according to the image signal. The second polarizing plate 116d is a polarizing plate that cuts off s-polarized light and causes p-polarized light to pass therethrough. Accordingly, the liquid crystal light valve 116 modulates green light G according to the image signal, and emits modulated green light G toward the cross dichroic prism 119.

The liquid crystal light valve 117 is a transmission-type liquid crystal apparatus that modulates blue light B, which is reflected in the dichroic mirror 113 and passes through the relay system 120 after passing through the dichroic mirror 114, according to the image signal. The liquid crystal light valve 117 includes a λ/2 phase difference plate 117a, a first polarizing plate 117b, an electro-optical device 100 (blue electro-optical device 100B), and a second polarizing plate 117d, similar to the liquid crystal light valves 115 and 116. Blue light B, which is incident on the liquid crystal light valve 117, is reflected in the two reflection mirrors 125a and 125b of the relay system 120 after being reflected in the dichroic mirror 113 and passing through the dichroic mirror 114, and thus blue light B becomes s-polarized light.

The λ/2 phase difference plate 117a is an optical element that converts s-polarized light, which is incident on the liquid crystal light valve 117, into p-polarized light. The first polarizing plate 117b is a polarizing plate that cuts off s-polarized light and causes p-polarized light to pass therethrough. The electro-optical device 100 (blue electro-optical device 100B) is formed to convert p-polarized light into s-polarized light (in a case of halftone, circularly polarized light or elliptically polarized light) through modulation according to the image signal. The second polarizing plate 117d is a polarizing plate that cuts off p-polarized light and causes s-polarized light to pass therethrough. Accordingly, the liquid crystal light valve 117 modulates blue light B according to the image signal, and emits modulated blue light B toward the cross dichroic prism 119. Meanwhile, the λ/2 phase difference plate 117a and the first polarizing plate 117b are disposed in a state in which the λ/2 phase difference plate 117a and the first polarizing plate 117b come into contact with a glass plate 117e.

The relay system 120 includes relay lenses 124a and 124b and reflection mirrors 125a and 125b. The relay lenses 124a and 124b are provided to prevent optical loss due to long optical path of blue light B. The relay lens 124a is disposed between the dichroic mirror 114 and the reflection mirror 125a. The relay lens 124b is disposed between the reflection mirrors 125a and 125b. The reflection mirror 125a reflects blue light B, which passes through the dichroic mirror 114 and is emitted from the relay lens 124a, toward the relay lens 124b. The reflection mirror 125b reflects blue light B, which is emitted from the relay lens 124b, toward the liquid crystal light valve 117.

The cross dichroic prism 119 is a color synthesis optical system in which two dichroic films 119a and 119b are perpendicularly disposed in an X-shape. The dichroic film 119a is a film which reflects blue light B and causes green light G to pass therethrough, and the dichroic film 119b is a film which reflects red light R and causes green light G to pass therethrough. Accordingly, the cross dichroic prism 119 synthesizes red light R, green light G, and blue light B which are modulated in respective liquid crystal light valves 115 to 117, and emits synthesized light toward the projection optical system 118.

Meanwhile, light which is incident on the cross dichroic prism 119 from the liquid crystal light valves 115 and 117 is s-polarized light, and light which is incident on the cross dichroic prism 119 from the liquid crystal light valve 116 is p-polarized light. As above, in a case where light which is incident on the cross dichroic prism 119 is converted into different types of polarized light, it is possible to synthesize light which is incident on each of the liquid crystal light valves 115 to 117 in the cross dichroic prism 119. Here, generally, the dichroic films 119a and 119b are excellent in reflectance properties of s-polarized light. Therefore, it is assumed that red light R and blue light B which are reflected in the dichroic films 119a and 119b are s-polarized light and green light G which passes through the dichroic films 119a and 119b is p-polarized light. The projection optical system 118 includes projection lenses (not shown in the drawing), and projects light which is synthesized in the cross dichroic prism 119 on to a projection member 111 such as the screen.

### Other Projection-Type Display Apparatuses

In the embodiment, although the λ/2 phase difference plates 115a, 116a, and 117a are disposed as the optical compensation elements, optical compensation elements, such as a C plate and an O plate, may be disposed. In this case, it is preferable that the optical compensation elements be provided between the electro-optical device 100 and the light source section 161. In the projection-type display apparatus, an LED light source, which emits light of the respective colors, or the like may be used as the light source section, and respective pieces of color light which are emitted from the LED light sources may be supplied to separate liquid crystal apparatuses.

The electro-optical device 100 to which the invention is applied may be used for a projection-type Head-Up Display (HUD) or a direct viewing type Head Mounted Display (HMD), a mobile phone, a Personal Digital Assistants (PDA), a digital camera, a liquid crystal television, a car navigation apparatus, a video phone and the like, in addition to the electronic apparatus.

The entire disclosure of Japanese Application No. 2016-074975 field Apr. 4, 2016 is expressly incorporated by reference herein.

What is claimed is:

1. An electro-optical device comprising:
an element substrate that is provided with pixel electrodes and pixel switching elements which are electrically connected to the pixel electrodes;
a counter substrate that is provided with common electrodes which face the pixel electrodes; and
an electro-optical layer that is provided between the element substrate and the counter substrate,
wherein the element substrate includes
a lens array substrate that is provided with a first lens surface, which includes a concave surface or a convex surface that overlaps the pixel electrodes, and a first light-transmitting lens layer which covers the first lens surface, and
a layered structure that is pasted to one surface side of the lens array substrate through an adhesive layer and that is configured to include a plurality of films having a film which forms the pixel switching elements and a film that forms the pixel electrodes.

2. The electro-optical device according to claim 1,
wherein the lens array substrate is provided with a light-shield layer that overlaps the semiconductor layer of the pixel switching elements.

3. The electro-optical device according to claim 2,
wherein the light-shield layer is provided on one surface side that is located on a side of the layered structure of the lens array substrate.

4. The electro-optical device according to claim 2,
wherein the light-shield layer includes a light reflection layer, which is located on a side opposite to the layered structure, and an optical absorption layer which is laminated on the light reflection layer on a side of the layered structure.

5. The electro-optical device according to claim 2,
wherein the layered structure is provided with a first alignment mark on the same layer as any one of the plurality of films, and
wherein the lens array substrate is provided with a second alignment mark on the same layer as the light-shield layer.

6. The electro-optical device according to claim 1,
wherein the lens array substrate is provided with the first lens surface and the first lens layer on another surface side which is located on a side opposite to the layered structure.

7. The electro-optical device according to claim 1,
wherein the lens array substrate is provided with a light-transmitting film on a side of the layered structure rather than the first lens surface and the first lens layer.

8. The electro-optical device according to claim 1,
wherein the counter substrate is provided with a second lens surface, which includes a concave surface or a convex surface that overlaps the pixel electrodes in plan view, and a second light-transmitting lens layer which covers the second lens surface.

9. An electronic apparatus comprising the electro-optical device according to claim 1.

10. An electronic apparatus comprising the electro-optical device according to claim 2.

11. An electronic apparatus comprising the electro-optical device according to claim 3.

12. An electronic apparatus comprising the electro-optical device according to claim 4.

13. An electronic apparatus comprising the electro-optical device according to claim 5.

14. An electronic apparatus comprising the electro-optical device according to claim 6.

15. The electronic apparatus according to claim 9, further comprising:
a light source section that causes light to be incident on the electro-optical device from a side of the element substrate.

16. A method of manufacturing an electro-optical device, which includes an element substrate that is provided with pixel electrodes and pixel switching elements which are electrically connected to the pixel electrodes; a counter substrate that is provided with common electrodes which face the pixel electrodes; and an electro-optical layer that is provided between the element substrate and the counter substrate, the method comprising:
forming the element substrate including
forming a plurality of films having a film that forms the pixel switching elements on one surface side of the substrate and a film that forms the pixel electrodes;
acquiring a layered structure that includes the plurality of films by removing the substrate from another surface side; and
pasting a surface, on which the substrate is located, to a lens array substrate that is provided with a first lens surface, which includes a concave surface or a convex surface, and a first light-transmitting lens layer, which covers the first lens surface, in the layered structure such that the pixel electrodes overlap the first lens surface.

17. The method of manufacturing an electro-optical device according to claim 16,
wherein the lens array substrate is provided with a light-shield layer that overlaps a semiconductor layer of the pixel switching elements in plan view in a case where the layered structure is pasted to the lens array substrate.

18. The method of manufacturing an electro-optical device according to claim 17,
wherein the forming of the plurality of films includes forming a first alignment mark by any one of the plurality of films,
wherein, in the lens array substrate, a second alignment mark on the same layer as the light-shield layer is formed, and
wherein the pasting of the surface includes aligning the layered structure with the lens array substrate by the first alignment mark and the second alignment mark.

19. The method of manufacturing an electro-optical device according to claim 16,
wherein, in the lens array substrate, the first lens surface and the first lens layer are provided on another surface side which is located on a side opposite to the layered structure.

20. The method of manufacturing an electro-optical device according to claim 16,
wherein the forming of the plurality of films includes forming the plurality of films after forming an etching stopper layer on one surface side of the substrate, and
wherein the acquiring of the layered structure includes etching the substrate to remove the substrate until reaching at least the etching stopper layer, and removing the etching stopper layer after the etching of the substrate.
